(19) United States
(12) Patent Application Publication
(10) Pub. No.: US 2026/0186102 A1
(43) Pub. Date: Jul. 2, 2026

(54) LIDAR SYSTEM

(71) Applicant: Y.E. Hub Armenia LLC, Yerevan (AM)

(72) Inventors: Georgii NIKANDROV, Moscow (RU); Aleksandr TIMOFEEVSKII, Moscow (RU)

(21) Appl. No.: 19/255,417

(22) Filed: Jun. 30, 2025

(30) Foreign Application Priority Data
Dec. 28, 2024 (RU) 2024140322

(51) Int. Cl. G01S 7/481; G01S 17/931

(52) U.S. Cl. CPC G01S 7/4813; G01S 7/4817; G01S 17/931

(57) ABSTRACT

A LiDAR system comprising a housing, the housing including a scanning unit, and a detection unit, the housing further comprising an optical window, the optical window made of a silicon with heat-conducting properties being higher than of conventional glass; the optical window further comprising: a wear-resistant coating applied to at least an exterior surface of the optical window; at least one heating element located on an edge of at least an exterior surface of the optical window.

### CROSS-REFERENCE

The present application claims priority to Russian Patent Application No. 2024140322, entitled “LIDAR SYSTEM”, filed Dec. 28, 2024, the entirety of which is incorporated herein by reference.

### TECHNICAL FIELD

The present technology relates generally to Light Detection and Ranging systems (LIDAR); and in particular, to a LIDAR system.

### BACKGROUND

Self-Driving Cars (SDCs) are vehicles that are able to autonomously drive themselves through private and/or public spaces. Using a system of sensors that detect the location and/or surroundings of the SDC, logic within or associated with the SDC controls the speed, propulsion, braking, and steering of the SDC based on the sensor-detected location and surroundings of the SDC.

A variety of sensor systems may be used by the SDC, such as but not limited to camera systems, radar systems, and Light Detection and Ranging (LiDAR) systems. Different sensor systems may be employed for capturing different information, and/or in different format, about the location and the surroundings of the SDC. For example, camera systems may be used for capturing image data about the surroundings of the SDC. In another example, LiDAR systems may be used to capture point cloud data for not only ranging objects but also building 3D map representations of the surroundings and other potential objects located in proximity to the SDC. Camera systems and LiDAR systems, amongst others, are implemented with one or more optical elements for capturing data. Weather factors such as rain and dirt may occlude optical elements of one or more sensor systems which reduces the quality of information gathered by the sensor systems for safely operating the SDC.

US Patent application no. 2019/210570 discloses a system having a computer for determining an amount of occluding material on a vehicle sensor, determining a temperature of the vehicle sensor, and actuating a liquid pump arranged to pump liquid to the vehicle sensor and an air pump arranged to pump air to the vehicle sensor based on the amount of occluding material and the temperature.

To improve the detection of objects in a self-driving vehicle, it is possible to use a LiDAR together with a camera and visualise the objects in both the LiDAR point cloud and the camera image.

The LiDAR system used by Yandex SDC consists of a light source, a scanning unit and a detection unit. The scanning unit can include a galvo mirror and a prism with n faces.

A light beam emitted by the light source is then reflected by the scanning unit and propagated to the surrounding objects. The light beam reflected by the surrounding objects travels back and is detected by a detection unit. As the light source emits the beams at a predetermined range of wavelengths, the detection unit then receives the input beam (reflected from the surrounding objects) at the same range of wavelengths.

In addition, the LiDAR device, which is enclosed in a housing, contains a window through which the light beams are emitted and received.

In low temperature conditions, the surface of the window can freeze to such an extent that it cannot be melted without breaking or damaging the window itself.

US Patent Application Publication no. US20220171026A1 discloses a replaceable antireflective sticker comprising a substrate with a thickness less than 5 mm, an antireflective coating on one side of the substrate, and a coupling surface for detachably coupling the antireflective sticker to a window of a LiDAR system.

Chinese Patent Application Publication no. CN110095828A discloses optical devices with specific optical and engineering properties. One type of optical device consists of a substrate and a coating applied to the substrate. This optical device features a first side exposed to the environment and an unexposed second side.

U.S. Pat. No. 10,377,373B2 discloses a vehicle and Laser Detection and Ranging (LADAR) sensor assembly system which makes use of forward mounted long range LADAR sensors and short range LADAR sensors mounted in auxiliary lamps to identify obstacles and to identify potential collisions with the vehicle. A low cost assembly is developed which can be easily mounted within a body panel cutout of a vehicle, and which connects to the vehicle electrical and computer systems through the vehicle wiring harness. The vehicle has a digital processor which interprets 3D data received from the LADAR sensor assembly, and which is in control of the vehicle subsystems for steering, braking, acceleration, and suspension. The digital processor onboard the vehicle makes use of the 3D data and the vehicle control subsystems to avoid collisions and steer a best path.

Japanese Patent Application Publication no. JP2020148973A discloses an optical deflection element that rotates a movable unit including a reflection surface to deflect light incident on the reflection surface. The movable unit is formed of a first layer and a second layer, the first layer has the reflection surface, and the entire first layer excluding the reflection surface is formed only one of silicon carbide, alumina, sapphire, silicon nitride, zirconia, diamond, and a compound having those as main components.

US Patent Application Publication no. US2021181547A1 LiDAR discloses a LiDAR apparatus that includes an optical emission source configured to emit an optical signal having a wavelength that varies based on a temperature of the optical emission source and/or an optical filter element that is configured to receive a reflection of the optical signal, the optical filter element having a passband that varies based on a temperature of the optical filter element; a thermal controller that is configured to generate a thermal control signal responsive to a temperature measurement related to the optical emission source or the optical filter element; and a temperature control element that is configured to adjust a temperature of the optical emission source or the optical filter element responsive to the thermal control signal.

International Patent Application Publication no. WO2023091305A1 discloses a window for a sensing system that includes a first layered film and a second layered film. The first and second layered film each include alternating layers of lower and higher refractive index materials. The first layered film includes a scratch resistant layer such that the window exhibits a maximum nanoindentation hardness of greater than or equal to 10 GPa when indented on the first layered film. The materials and thicknesses of the layers of the first and second layered films are selected such that the window exhibits relatively high transmittance and low reflectance in two distinct wavelength ranges of interest.

In an article entitled “Optical Protective Window Design and Material Selection Issues in the Multi-Sensor Electro-Optical Surveillance Systems”, authored by Vujic et al., and published at Sensor in March 2023, there is disclosed a methodology and practical recommendation for how to define optical protective window specifications in multi-sensor imaging systems, using a system engineering approach. In addition, there is disclosed a set of data and calculation tools that can be used in analysis to provide proper window material selection and definition of the specifications of optical protective windows in multi-sensor systems.

In an article entitled “On-Chip Diamond Raman Laser”, authored by Latawiec et al., and published at Optica in October 2015, there is disclosed an on-chip Raman laser based on fully integrated, high-quality-factor, diamond racetrack microresonators embedded in silica. Pumping at telecom wavelengths, the article demonstrates Stokes output discretely tunable over a ˜100 nm bandwidth around 2 μm with output power >250 μW, extending the functionality of diamond Raman lasers to an interesting wavelength range at the edge of the mid-infrared spectrum. Continuous-wave operation with only ˜85 mW pump threshold power in the feeding waveguide is demonstrated along with continuous, mode-hop-free tuning over ˜7.5 GHz in a compact, integrated-optics platform.

### SUMMARY

Developers have devised methods and devices for overcoming at least some drawbacks present in prior art solutions.

Broadly speaking, at least some of the non-limiting embodiments of the present technology aim to expand the number of technical means of special aim. Specifically, at least some of the non-limiting embodiments of the present technology aim to expand the number of LiDARs having optical window that can be heated evenly to avoid freezing of its surface. In at least of the non-limiting embodiments of the present technology, the optical window can be evenly heated throughout the surface (or a portion thereof), and can assist in preventing frozen elements (such as, ice) from being accumulated. In some non-limiting embodiments of the present technology, additionally or alternatively, the window is protected by a reinforcing coating to render it more durable to external impacts.

In accordance with at least some of the non-limiting embodiments of the present technology, a LiDAR system is provided, the LiDAR system comprises an optical window made of silicon, the optical window having a heating element. In some of the non-limiting embodiments of the present technology, the optical window further comprises a wear-resistant protective coating. The protective coating can, for example, be made of a material selected for providing a resistible heat-conductive properties.

The silicon is characterized by increased heat-conductivity compared to conventional glass and therefore is suitable for conducting the heat from the heating means throughout its surface. It is known in the art that such materials (silicon) are easier to scratch and can be damaged by elements like small stones, dirt, etc. To address this, non-limiting embodiments of the present technology contemplate adding a wear-resistant Diamond-Like Carbon (DLC) coating reinforcing the optical window.

It is counterintuitive to use pure silicon as it has low mechanical strength and is prone to material degradation over time.

Non-limiting embodiments of the present technology are directed to a LiDAR comprising an optical window made of silicon, which is used instead of the conventional glass window.

In accordance with the non-limiting embodiments of the present technology, the silicon material can be selected to have transmission spectra of commercially available silicon.

In accordance with the non-limiting embodiments of the present technology, a heating element can be installed in such a way so that not to obstruct the field of view of the LiDAR sensor.

In accordance with the non-limiting embodiments of the present technology, the main difference between the silicon-based optical window and conventional glass, which also contains silicon but as an oxide (SiO₂), is that the silicon itself is a crystalline material, whereas conventional glass is an amorphous substance.

In accordance with the non-limiting embodiments of the present technology, a Diamond-Like Carbon (DLC) can be used. It is characterized by the highest resistance to salts, acids, alkalis, and most organic solvents. Its high mechanical hardness and low coefficient of friction make it extremely resistant to abrasive influences. Additionally, the low coefficient of friction of DLC minimizes the adherence of pollutants, thereby facilitating the cleaning process.

In accordance with the non-limiting embodiments of the present technology, the DLC coating is used to protect external optical surfaces from the abrasive effects of airborne dust particles, seawater and salt, engine oil and fuel, high humidity, improper handling, etc.

In accordance with the non-limiting embodiments of the present technology, a DLC film can be used. The DLC film can be selected such as to be characterized by a moderate level of absorption and scattering throughout the infrared wavelength range. The refractive index of the DLC film in the IR range is between about 1.8 and 2.2.

In the context of the present specification, the term “light source” broadly refers to any device configured to emit radiation such as a radiation signal in the form of a beam, for example, without limitation, a light beam including radiation of one or more respective wavelengths within the electromagnetic spectrum. In one example, the light source can be a “laser source”. Thus, the light source could include a laser such as a solid-state laser, laser diode, a high power laser, or an alternative light source such as, a light emitting diode (LED)-based light source. Some (non-limiting) examples of the laser source include: a Fabry-Perot laser diode, a quantum well laser, a distributed Bragg reflector (DBR) laser, a distributed feedback (DFB) laser, a fiber-laser, or a vertical-cavity surface-emitting laser (VCSEL). In addition, the laser source may emit light beams in differing formats, such as light pulses, continuous wave (CW), quasi-CW, and so on. In some non-limiting examples, the laser source may include a laser diode configured to emit light at a wavelength between about 1.1 microns and 1.6 microns. Unless indicated otherwise, the term “about” with regard to a numeric value is defined as a variance of up to 10% with respect to the stated value.

In the context of the present specification, an “output beam” may also be referred to as a radiation beam, such as a light beam, that is generated by the radiation source and is directed downrange towards a region of interest. The output beam may have one or more parameters such as: beam duration, beam angular dispersion, wavelength, instantaneous power, photon density at different distances from light source, average power, beam power intensity, beam width, beam repetition rate, beam sequence, pulse duty cycle, wavelength, or phase etc. The output beam may be unpolarized or randomly polarized, may have no specific or fixed polarization (e.g., the polarization may vary with time), or may have a particular polarization (e.g., linear polarization, elliptical polarization, or circular polarization).

In the context of the present specification, an “input beam” is radiation or light entering the system, generally after having been reflected from one or more objects. The “input beam” may also be referred to as a radiation beam or light beam. By reflected is meant that at least a portion of the output beam incident on one or more objects, bounces off the one or more objects. The input beam may have one or more parameters such as: time-of-flight (i.e., time from emission until detection), instantaneous power (e.g., power signature), average power across entire return pulse, photon distribution/signal over return pulse period, and phase shift or frequency shift etc. Depending on the particular usage, some radiation or light collected in the input beam could be from sources other than a reflected output beam. For instance, at least some portion of the input beam could include light-noise from the surrounding environment (including scattered sunlight) or other light sources exterior to the present system.

In the context of the present specification, the term “surroundings” of a given vehicle refers to an area or a volume around the given vehicle including a portion of a current environment thereof accessible for scanning using one or more sensors mounted on the given vehicle, for example, for generating a 3D map of the such surroundings or detecting objects therein.

In the context of the present specification, “Diamond-Like Carbon (DLC)” refers to a class of amorphous carbon material that exhibits some of the typical properties of diamond. These properties include high hardness, chemical inertness, low friction, and high wear resistance. DLC can be applied as a thin film coating to enhance the surface properties of various materials, making them more durable and resistant to corrosion, wear, and abrasion.

In at least one aspect of the present technology, there is provided a LiDAR system comprising a housing, the housing including a scanning unit, and a detection unit, the housing further comprising an optical window, the optical window made of a silicon with heat-conducting properties being higher than of conventional glass; the optical window further comprising: a wear-resistant coating applied to at least an exterior surface of the optical window; at least one heating element located on an edge of at least an exterior surface of the optical window.

In some embodiments of the LiDAR system, the silicon is optical grade silicon.

In some embodiments of the LiDAR system, the silicon is pure silicon.

In some embodiments of the LiDAR system, the wear-resistance coating is a Diamond-Like Carbon (DLC) applied to at least an exterior surface of optical window for providing wear-resistance properties to the optical window of the LiDAR system.

In some embodiments of the LiDAR system, the wear-resistance coating is one of an oxide coating or a salt coating.

In some embodiments of the LiDAR system, the oxide coating is Al₂O₃.

In some embodiments of the LiDAR system, the salt coating is one of ZnS, YF₃—ZnS, and YbF₃—ZnS.

In some embodiments of the LiDAR system, the at least one heating element is an electrical resistive heating element.

In some embodiments of the LiDAR system, the electrical resistive heating element is a Nichrome wire.

In some embodiments of the LiDAR system, the at least one heating element is a nozzle configured to direct a flow of heated air on the optical window.

In some embodiments of the LiDAR system, an antireflective coating is applied to at least an internal surface of the optical window for optical radiance in an operating wavelength range of the LiDAR system.

In some embodiments of the LiDAR system, the housing further comprises a filter configured to block signals having wavelengths outside the operating wavelength range of the LiDAR system and transmit signals having wavelengths within the operating wavelength range of the LiDAR system.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system configurable for implementing certain non-limiting embodiments of the present technology.

FIG. 2 depicts a schematic diagram of a networked computing environment being suitable for use with certain non-limiting embodiments of the present technology.

FIG. 3 illustrates example transmission of commercially available silicon (https://www.tydexoptics.com/materials1/ for_transmission_optics/silicon/) in the spectral range of 1-25 microns for samples having thickness of 5 mm, suitable for use with certain non-limiting embodiments of the present technology.

FIG. 4 illustrates example transmission of commercially available silicon (https://www.tydexoptics.com/materials1/for_transmission_optics/silicon/), grown by the zone melting method (FZ-Si) and the Optical Czochralski Silicon (OCz-Si), in the spectral range of 2-14 microns for samples having different values of thickness, suitable for use with certain non-limiting embodiments of the present technology.

FIG. 5 illustrates a top view of the LiDAR's optical window with DLC coating and anti-reflective coating, suitable for use with certain non-limiting embodiments of the present technology.

FIG. 6 illustrates a side view of the LiDAR's optical window with DLC coating and anti-reflective coating, suitable for use with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

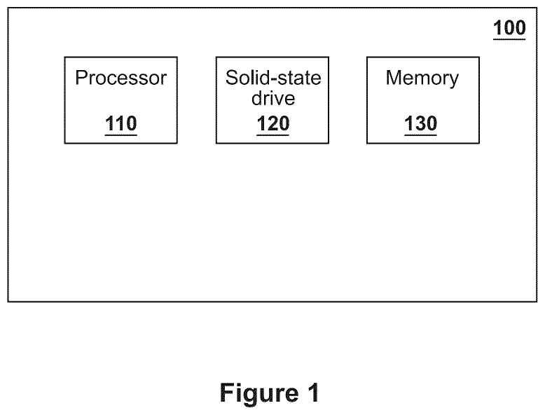

Referring initially to FIG. 1, there is depicted a schematic diagram of a computer system 100 suitable for use with some implementations of the present technology. The computer system 100 includes various hardware components including one or more single or multi-core processors collectively represented by a processor 110, a solid-state drive 120, and a memory 130, which may be a random-access memory or any other type of memory.

Communication between the various components of the computer system 100 may be enabled by one or more internal and/or external buses (not shown) (e.g. a PCI bus, universal serial bus, IEEE 1394 “Firewire” bus, SCSI bus, Serial-ATA bus, etc.), to which the various hardware components are electronically coupled. According to embodiments of the present technology, the solid-state drive 120 stores program instructions suitable for being loaded into the memory 130 and executed by the processor 110 for determining a presence of an object. For example, the program instructions may be part of a vehicle control application executable by the processor 110. It is noted that the computer system 100 may have additional and/or optional components (not depicted), such as network communication modules, localization modules, and the like.

In some non-limiting embodiments of the present technology, the computer system 100 may be implemented by any of a conventional personal computer, a controller, and/or an electronic device (e.g., a server, a controller unit, a control device, a monitoring device etc.) and/or any combination thereof appropriate to the relevant task at hand. In some other embodiments, the computer system 100 may be an “off the shelf” generic computer system. In some non-limiting embodiments of the present technology, the computer system 100 may also be distributed amongst multiple systems. The computer system 100 may also be specifically dedicated to the implementation of the present technology. As a person in the art of the present technology may appreciate, multiple variations as to how the computer system 100 is implemented may be envisioned without departing from the scope of the present technology.

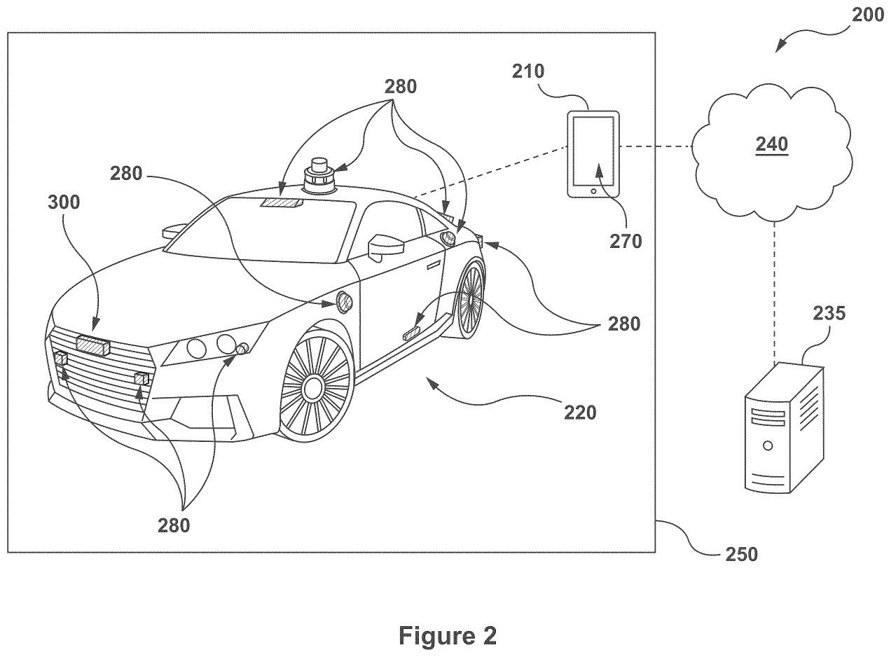

With reference to FIG. 2, there is depicted a networked computing environment 200, including the vehicle 220, suitable for use with some non-limiting embodiments of the LiDAR system 300. The networked computing environment 200 includes an electronic device 210 associated with a vehicle 220 and/or associated with a user (not depicted) who is associated with the vehicle 220 (such as an operator of the vehicle 220). The environment 200 also includes a server 235 in communication with the electronic device 210 via a communication network 240 (e.g. the Internet or the like, as will be described in greater detail herein below).

In at least some non-limiting embodiments of the present technology, the electronic device 210 is communicatively coupled to control systems of the vehicle 220. The electronic device 210 could be arranged and configured to control different operations systems of the vehicle 220, including but not limited to: an ECU (engine control unit), steering systems, braking systems, and signaling and illumination systems (i.e. headlights, brake lights, and/or turn signals). In such an embodiment, the vehicle 220 could be a self-driving vehicle 220.

In some non-limiting embodiments of the present technology, the networked computing environment 200 could include a GPS satellite (not depicted) transmitting and/or receiving a GPS signal to/from the electronic device 210. It will be understood that the present technology is not limited to GPS and may employ a positioning technology other than GPS. It should be noted that the GPS satellite can be omitted altogether.

The vehicle 220, to which the electronic device 210 is associated, could be any transportation vehicle, for leisure or otherwise, such as a private or commercial car, truck, motorbike or the like. Although the vehicle 220 is depicted as being a land vehicle, this may not be the case in each and every non-limiting embodiment of the present technology. For example, in certain non-limiting embodiments of the present technology, the vehicle 220 may be a watercraft, such as a boat, or an aircraft, such as a flying drone.

The vehicle 220 may be user operated or a driver-less vehicle. In some non-limiting embodiments of the present technology, it is contemplated that the vehicle 220 could be implemented as a Self-Driving Car (SDC). It should be noted that specific parameters of the vehicle 220 are not limiting, these specific parameters including for example: vehicle manufacturer, vehicle model, vehicle year of manufacture, vehicle weight, vehicle dimensions, vehicle weight distribution, vehicle surface area, vehicle height, drive train type (e.g. 2× or 4×), tire type, brake system, fuel system, mileage, vehicle identification number, and engine size.

According to the present technology, the implementation of the electronic device 210 is not particularly limited. For example, the electronic device 210 could be implemented as a vehicle engine control unit, a vehicle CPU, a vehicle navigation device (e.g. TomTom™ Garmin™), a tablet, a personal computer built into the vehicle 220, and the like. Thus, it should be noted that the electronic device 210 may or may not be permanently associated with the vehicle 220. Additionally or alternatively, the electronic device 210 could be implemented in a wireless communication device such as a mobile telephone (e.g. a smart-phone or a radio-phone). In certain embodiments, the electronic device 210 has a display 270.

The electronic device 210 could include some or all of the components of the control unit 100 depicted in FIG. 2, depending on the particular embodiment. In certain embodiments, the electronic device 210 is an on-board computer device and includes the processor 110, the solid-state drive 120 and the memory 130. In other words, the electronic device 210 includes hardware and/or software and/or firmware, or a combination thereof, for processing data as will be described in greater detail below.

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the electronic device 210 and the communication network 240, the implementation of which will depend, inter alia, on how the electronic device 210 is implemented. Merely as an example and not as a limitation, in those non-limiting embodiments of the present technology where the electronic device 210 is implemented as a wireless communication device such as a smartphone or a navigation device, the communication link can be implemented as a wireless communication link. Examples of wireless communication links may include, but are not limited to, a 3G communication network link, a 4G communication network link, and the like. The communication network 240 may also use a wireless connection with the server 235.

In some embodiments of the present technology, the server 235 is implemented as a computer server and could include some or all of the components of the control unit 100 of FIG. 2. In one non-limiting example, the server 235 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 235 is a single server. In alternative non-limiting embodiments of the present technology, the functionality of the server 235 may be distributed and may be implemented via multiple servers (not shown).

In some non-limiting embodiments of the present technology, the processor 110 of the electronic device 210 could be in communication with the server 235 to receive one or more updates. Such updates could include, but are not limited to, software updates, map updates, routes updates, weather updates, and the like. In some non-limiting embodiments of the present technology, the processor 110 can also be configured to transmit to the server 235 certain operational data, such as routes travelled, traffic data, performance data, and the like. Some or all such data transmitted between the vehicle 220 and the server 235 may be encrypted and/or anonymized.

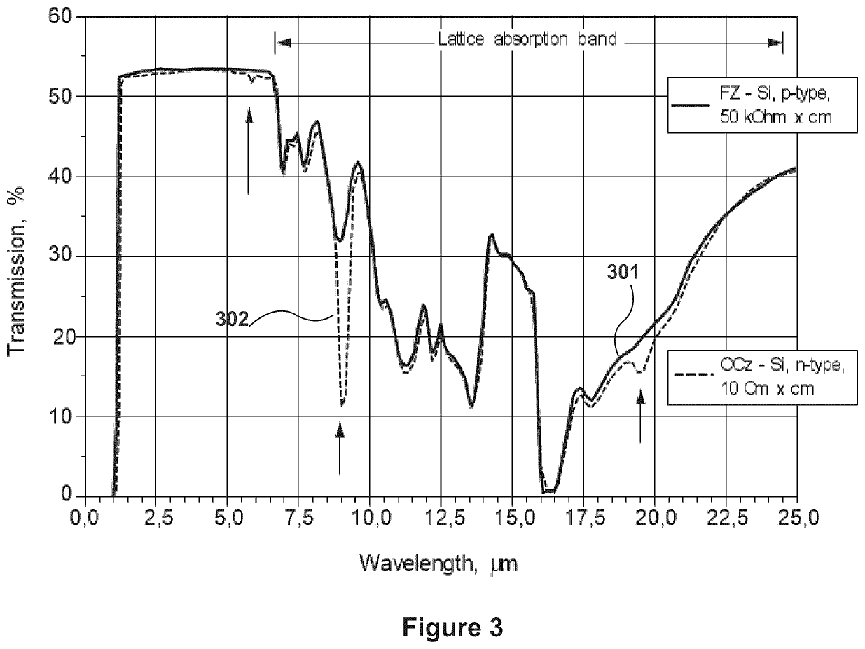

It should be noted that a variety of sensors and systems may be used by the electronic device 210 for gathering information about surroundings 250 of the vehicle 220. As seen in FIG. 3, the vehicle 220 may be equipped with a plurality of sensor systems 280. It should be noted that different sensor systems from the plurality of sensor systems 280 may be used for gathering different types of data regarding the surroundings 250 of the vehicle 220.

In one example, the plurality of sensor systems 280 may include various optical systems including, inter alia, one or more camera-type sensor systems that are mounted to the vehicle 220 and communicatively coupled to the processor 110 of the electronic device 210. Broadly speaking, the one or more camera-type sensor systems may be configured to gather image data about various portions of the surroundings 250 of the vehicle 220. In some cases, the image data provided by the one or more camera-type sensor systems could be used by the electronic device 210 for performing object detection procedures. For example, the electronic device 210 could be configured to feed the image data provided by the one or more camera-type sensor systems to an Object Detection Neural Network (ODNN) that has been trained to localize and classify potential objects in the surroundings 250 of the vehicle 220.

In another example, the plurality of sensor systems 280 could include one or more radar-type sensor systems that are mounted to the vehicle 220 and communicatively coupled to the processor 110. Broadly speaking, the one or more radar-type sensor systems may be configured to make use of radio waves to gather data about various portions of the surroundings 250 of the vehicle 220. For example, the one or more radar-type sensor systems may be configured to gather radar data about potential objects in the surroundings 250 of the vehicle 220, such data potentially being representative of a distance of objects from the radar-type sensor system, orientation of objects, velocity and/or speed of objects, and the like.

In a further example, the plurality of sensor systems 280 could include one or more Light Detection and Ranging (LiDAR) systems that are mounted to the vehicle 220 and communicatively coupled to the processor 110, in addition to the LiDAR system 300 described above. The LiDAR system 300 could be mounted, or retrofitted, to the vehicle 220 in a variety of locations and/or in a variety of configurations for gathering information about surroundings 250 of the vehicle 220.

For example, depending on the implementation of the vehicle 220 and the LiDAR system 300, the LiDAR system 300 could be mounted on an interior, upper portion of a windshield of the vehicle 220. Nevertheless, other locations for mounting the LiDAR system 300 are within the scope of the present disclosure, including on a back window, side windows, front hood, rooftop, front grill, front bumper or the side of the vehicle 220.

It should be noted that the LiDAR system 300 or an additional LiDAR system could be mounted in combination with one or more camera systems in a housing mounted on the top of the vehicle 220.

In accordance with at least some of the non-limiting embodiments of the present technology, the LiDAR system 300 comprises an optical window made of silicon instead of a conventional glass window.

In accordance with the non-limiting embodiments of the present technology, the silicon window can be manufactured using one of several methods. For example:
by the Czochralski method (OCz-Si or optical grade Czochralski silicon);
grown by zone melting (FZ-Si or float zone silicon).

It should be understood that other manufacturing methods can be used as well. These silicon materials are transparent in the infrared range and allow the window to be heated by attaching any heating means inside the LiDAR housing. For example, heating elements (boards with resistors) can be mounted on the interior side of the window along the perimeter in the form of a frame.

In accordance with the non-limiting embodiments of the present technology, the silicon material can be selected to be characterized with the properties of commercially available silicon. For example, the following is a list of example properties of commercially available silicon, available at the webpage “https://www.tydexoptics.com/materials1/for_transmission_optics/silicon”:

| | |
|---|---|
| Density, g/cm³ | 2.329 |
| Melting point, ° C. | 1412 |
| Molecular weight, g/mol | 28.09 |
| Surface tension (in the liquid state at the | 736 |
| melting point), mN/m | |
| Coefficient of linear thermal expansion at | 2.55 × 10⁻⁶ |
| 25° C., /° C. | |
| Thermal conductivity at 27° C, W/(m × ° C.) | 159 |
| Specific heat capacity (solid), J/(kg × ° C.) | 712 |
| Thermal coefficient of refractive index at 25 | 1.50 × 10⁻⁴ |
| ° C. | |
| Intrinsic resistance, kΩ × cm | 240 |
| 1 Ω × cm (n-type) is equal to, 10¹⁵ /cm³ | 2.93 |
| 1 Ω × cm (p-type) is equal to, 10¹⁵ /cm³ | 7.33 |
| Intrinsic electron drift mobility, cm² /(V × | 1500 |
| sec.) | |
| Number of intrinsic electrons, cm⁻³ | 1.22 × 10¹⁰ |
| Intrinsic hole drift mobility, cm² /(V × sec.) | 600 |
| Band gap, minimum, eV 300K, 0K | 1.14, 1.17 |
| Modulus of rupture, MPa | 125 |
| Mohs hardness | 7 |
| Young's Modulus (E), Pa | 1.89 × 10¹⁰ |
| The coefficient of transverse deformation | 0.266 |
| (Poisson's ratio) | |
| Shear modulus (G), Pa | 7.99 × 10¹⁰ |
| Solubility in water | insoluble |

With reference to FIG. 3, there is depicted an example transmission spectra of commercially available optical grade silicon in the spectral range of 1-25 microns for samples having thickness of 5 mm (https://www.tydexoptics.com/materials1/for_transmission_optics/silicon/), suitable for use with certain non-limiting embodiments of the present technology. In some non-limiting embodiments of the present technology, pure silicon may be used instead of optical grade silicon.

In FIG. 3, the transmission properties of two types of optical grade silicon, Float Zone Silicon (FZ-Si) 301 and Optical Czochralski Silicon (OCz-Si) 302, are presented as examples. The graph shows the transmission as a function of wavelength in microns. The data indicates that both types of optical grade silicon inherently block electromagnetic radiation with wavelengths below 1 micron and there is no significant difference in transmission between FZ-Si and OCz-Si when both materials possess equal resistance and conductivity type in the wavelength range up to 5 microns.

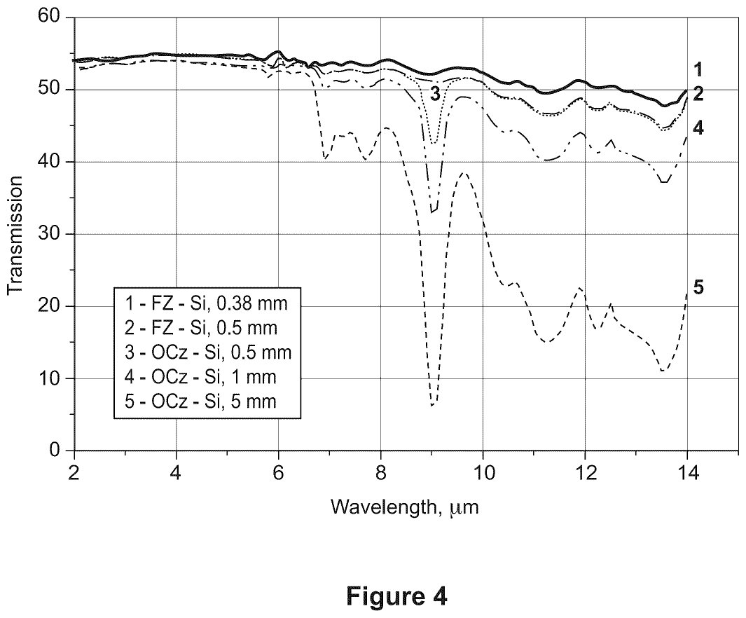

With reference to FIG. 4, there is depicted an example transmission spectra of commercially available silicon grown by the zone melting method (FZ-Si) and the Czochralski method (OCz-Si) over 2-14 microns for samples having different values of thickness (https://www.tydexoptics.com/materials1/for_transmission_optics/silicon/), suitable for use with certain non-limiting embodiments of the present technology.

In FIG. 4, transmission spectra for Float-Zone Silicon (FZ-Si) and Optical Czochralski Silicon (OCz-Si) having different thicknesses of silicon are depicted. The materials and the corresponding thicknesses of silicon are as follows: FZ-Si at 0.38 mm (graph 1) and 0.5 mm (graph 2); OCz-Si at 0.5 mm (graph 3), 1 mm (graph 4), and 5 mm (graph 5). The graph shows transmission percentage as a function of wavelength in microns.

The data in FIG. 4 indicates that for a wavelength range of 2-5 microns, commonly used in pyrometry and thermography, and extending to 6.5 microns, the dependence of the transmittance of FZ-Si and OCz-Si on silicon thickness is not substantial. Although the transmittance of FZ-Si and OCz-Si for wavelengths shorter than 2 microns is not shown in FIG. 4, it is well known in the art that the dependence of their transmittance on silicon thickness remains negligible even within the 1-2 microns wavelength range. For wavelengths shorter than 1 micron, the transmittance approaches zero. This characteristic makes optical grade silicon materials including FZ-Si and OCz-Si particularly useful for applications in these wavelength ranges, where consistent transmission is required regardless of material thickness. In some non-limiting embodiments of the present technology, the LiDAR system 300 may be configured to operate within a wavelength range of 1.44-1.66 microns. Therefore, optical grade silicon materials including FZ-Si and OCz-Si are suitable for implementing such non-limiting embodiments.

These silicon materials are transparent in the infrared range and allow the window to be heated by attaching any heating means inside the LiDAR housing. For example, heating elements (boards with resistors) can be mounted on the interior side of the window along the perimeter in the form of a frame.

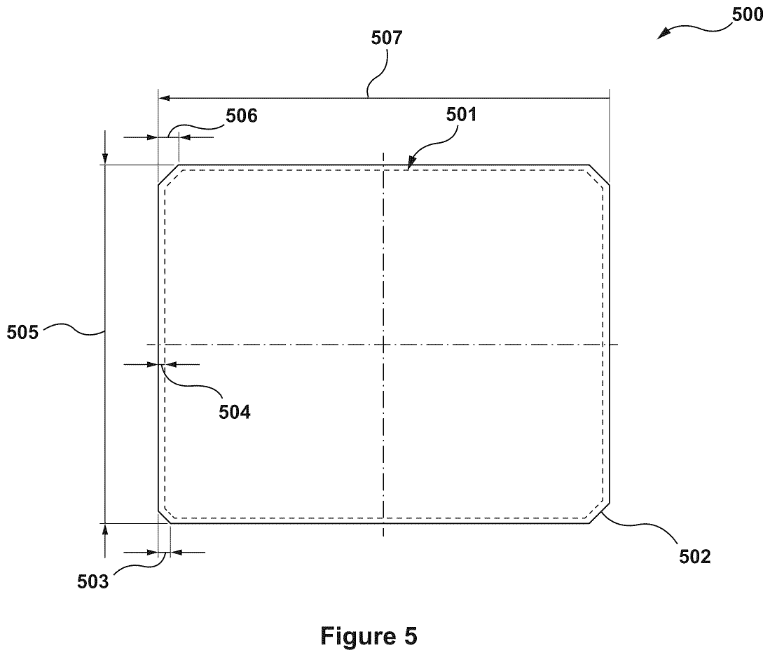

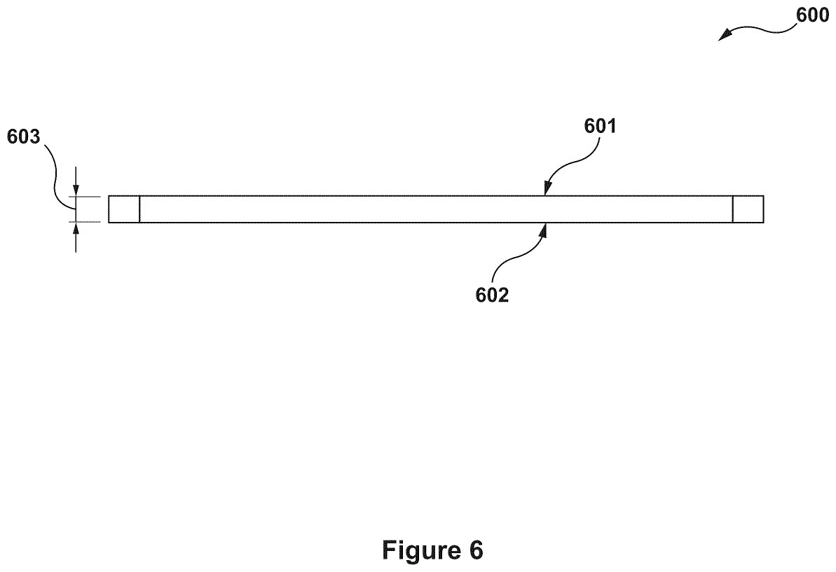

With reference to FIG. 5 and FIG. 6, there is depicted a top view 500 and a side view 600, respectively, of the LiDAR's optical window with DLC coating and anti-reflective coating, suitable for use with certain non-limiting embodiments of the present technology.

The LiDAR's optical window, as illustrated in FIG. 5 and FIG. 6, is defined with chamfered corners, for example, 502, and dimensions of approximately 74.0 mm in length 507, 59.0 mm in width 505, and 3.0 mm in thickness 603. As persons skilled in the art would understand, various implementations of the present technology may be of a greater complexity, but also of lesser complexity. By way of example, it is noted that the presence of chamfered corners is not an essential feature for achieving the technical objective of the present technology.

The central area, referred to as the “Clear Aperture” 501, allows passage of laser beams and reflected signals.

The LiDAR's optical window includes two surfaces, designated as Surface A 602 and Surface B 601, as shown in FIG. 6. Each of surface A and surface B is coated with specialized materials. In accordance with non-limiting embodiments of the present technology, the surfaces are configured to optimize optical radiance within an operating wavelength range of 1.54 to 1.56 microns. Surface A, as depicted in FIG. 6, is coated with a wear-resistant Diamond-Like Carbon (DLC) coating having a thickness in the wavelength range of 0.15-0.30 microns. At the wavelength of about 1.55 microns, this coating absorbs approximately 2% of the incident optical energy, and reflects approximately 2% of the incident optical energy. The total signal loss (a residual reflection loss) due to the DLC coating is lower than 5% at the wavelength range of 1.54 to 1.56 microns. The DLC coating operates across angles of incidence (AOI) ranging from −35 degrees to +35 degrees and within a temperature range of −40° C. to 85° C. Thus, DLC coatings exhibit high transmission at the operating wavelength, which, in certain embodiments of this technology, ranges from 1.54 to 1.56 microns. The transmission decreases outside the operating band.

In some non-limiting embodiments of the present technology, instead of the DLC coating, single-layer coatings of Al₂O₃, SiO, Y₂O₃, ZnS etc., having thickness in the range of 0.15-0.5 microns, can be used. In some non-limiting embodiments of the present technology, instead of DLC coating, dual-layer coatings of SiO₂—ZrO (or other combinations of oxides with varying refractive indices), YF₃—ZnS, YbF₃—ZnS etc., having thickness in the range of 0.15-0.5 microns, can be used. The durability and optical performance of the coating depends on the material used for the coating. For example, while DCL coating provides better durability compared to the other materials mentioned, it provides an inferior transmission and higher residual reflection.

Surface B, also illustrated in FIG. 6, is treated with an Anti-Reflective (AR) coating, which reduces reflections and maximizes the clarity of transmitted and received signals within the LiDAR's operational wavelength range. The AR coating maintains a residual reflection loss lower than 0.5% across angles of incidence (AOI) ranging from −35 degrees to +35 degrees and within a temperature range of −40° C. to 85° C. for a wavelength range of 1.54 to 1.56 microns. The surface is polished.

In some non-limiting embodiments of the present technology, the AR coating may be implemented using Al₂O₃, Y₂O₃, ZnO, ZnS, SiO₂—ZrO₂, YF₃—ZnS, Tbf₃-ZnS etc. In some non-limiting embodiments of the present technology, an optical filter, having the following filtering properties, may be used instead of the AR coating: act as a band-stop filter for short wave optical signals (i.e., optical signals having wavelengths of 1-1.44 microns) and long wave optical signals (i.e., optical signals having wavelengths longer than 1.66 microns), and act as a band-pass filter for optical signals having wavelengths of 1.44-1.66 microns. In some non-limiting embodiments of the present technology, the optical filter may be implemented using alternating pairs of layers of materials with high and low refractive indices, for example, Si—SiO₂ or ZnS—YF₃. The number of such layers required to implement the optical filter is several tens (for example, 30-50), and the total thickness of such layers required is several microns, for example, 5 microns.

In some non-limiting embodiments of the present technology, a heating element (not depicted) may be mounted on an edge of the optical window 500, 600 of the LiDAR system 300. The purpose of the heating element is to prevent fogging, frosting, or the accumulation of moisture on the surface of optical window 500, 600. In some non-limiting embodiments of the present technology, a Nichrome wire may be used as the heating element on the optical window 500, 600. In some non-limiting embodiments of the present technology, an electrical resistor may be used as the heating element on the optical window 500, 600. In some non-limiting embodiments of the present technology, a nozzle configured to direct a flow of heated air on the optical window may be used as the heating element on the optical window 500, 600.

The transmittance of the LiDAR's optical window exceeds 95% for optical radiance within the wavelength range of 1.54 to 1.56 microns, ensuring that the window transmits laser beams and receives reflected signals with minimal loss. In some non-limiting embodiments of the present technology, the surface quality of the coated window surpasses a 60-40 standard. Alternatively, the surface quality of the coated window may surpass an 80-50 standard or any other standard. Additionally, the window's flatness has a deviation of less than 20 lambda for 1.55 microns at the clear aperture 501.

The LiDAR's optical window with coating depicted in FIG. 5 and FIG. 6 operates optimally with minimal losses when subjected to optical radiance within the wavelength range of 1.54 to 1.56 microns, with an average power density of 20 W/mm² and pulse energies up to 100 J during extended periods. Surface roughness for untreated areas is specified to be equal to or greater than Ra2.5, while the clear aperture 501 is meticulously inspected to be free from bubbles, cracks, impurities, and defects larger than 0.1 mm. The edges, for example, 502, in FIG. 5, of the LiDAR's optical window may be chamfered, with a maximum chamfer size 506 of 0.2 mm. The edges of the component are beveled, for example, with a 2.0 mm×450 chamfer 503 or beveled with a 3.0 mm×45° chamfer 506, such that all sharp edges are dulled. The LiDAR window with coating can operate without loss of functionality in the presence of mounting or edge defects, for example, bubbles, cracks, impurities etc., given that these defects are within a length of 1 mm from the edge, as indicated by the numeral 504 in FIG. 5. As persons skilled in the art would understand, various implementations of the present technology may be configured with differing dimensions, and all parameters described above are provided for a specific, non-limiting embodiment; these parameters may vary depending on design requirements and intended applications.

It is contemplated that the shape of the LiDAR system's housing and optical window can vary without impacting the performance of the LiDAR system.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that some of these steps may be combined, sub-divided, or re-ordered without departing from the teachings of the present technology. Accordingly, the order and grouping of the steps is not a limitation of the present technology.

1. A LiDAR system comprising:
a housing, the housing including:
a scanning unit, and
a detection unit,
the housing further comprising an optical window, the optical window made of a silicon with heat-conducting properties being higher than of conventional glass;
the optical window further comprising:
a wear-resistant coating applied to at least an exterior surface of the optical window;
at least one heating element located on an edge of at least an exterior surface of the optical window.

2. The LiDAR system of claim 1, wherein the silicon is optical grade silicon.

3. The LiDAR system of claim 1, wherein the silicon is pure silicon.

4. The LiDAR system of claim 1, wherein the wear-resistance coating is a Diamond-Like Carbon (DLC) applied to at least an exterior surface of optical window for providing wear-resistance properties to the optical window of the LiDAR system.

5. The LiDAR system of claim 1, wherein the wear-resistance coating is one of an oxide coating or a salt coating.

6. The LiDAR system of claim 5, wherein the oxide coating is Al₂O₃.

7. The LiDAR system of claim 5, wherein the salt coating is one of ZnS, YF₃—ZnS, and YbF₃—ZnS.

8. The LiDAR system of claim 1, wherein the at least one heating element is an electrical resistive heating element.

9. The LiDAR system of claim 8, wherein the electrical resistive heating element is a Nichrome wire.

10. The LiDAR system of claim 1, wherein the at least one heating element is a nozzle configured to direct a flow of heated air on the optical window.

11. The LiDAR system of claim 1, wherein an antireflective coating is applied to at least an internal surface of the optical window for optical radiance in an operating wavelength range of the LiDAR system.

12. The LiDAR system of claim 1, the housing further comprising a filter configured to block signals having wavelengths outside the operating wavelength range of the LiDAR system and transmit signals having wavelengths within the operating wavelength range of the LiDAR system.
